(19) United States
(12) Patent Application Publication
(10) Pub. No.: US 2011/0149568 A1
(43) Pub. Date: Jun. 23, 2011

(54) LUMINAIRE

(75) Inventors: Barbara A. Wilson, Ann Arbor, MI (US); Joseph W. McElroy, Ann Arbor, MI (US)

(73) Assignee: OFF GRID CORPORATION, Ann Arbor, MI (US)

(21) Appl. No.: 12/858,098

(22) Filed: Aug. 17, 2010

Related U.S. Application Data
(60) Provisional application No. 61/234,439, filed on Aug. 17, 2009.

(51) Int. Cl. F21V 1/00

(52) U.S. Cl. 362/235

(57) ABSTRACT

A general illumination luminaire or lamp includes high efficacy and long life light emitting diodes (LEDs) as part of a light module. The LEDs are mounted on a strip that is mounted on a frame to position the LEDs in a circular, or at least round, path for providing increased light distribution and heat dissipation. The frame may take various forms to direct the light to be diffused and dispersed as is desired for a general illumination source. Diffusion layers or coatings are used to condition the light for desired distributed reflective characteristics. The luminaire uses electronics to condition and control the electricity provided to the LEDs from the power source, such as batteries.

### CLAIM OF PRIORITY

The present application claims the benefit of the filing date of U.S. Provisional Patent Application No. 61/234,439, filed on Aug. 17, 2009 entitled “LUMINAIRE” the contents of which are hereby incorporated by reference in its entirety.

### BACKGROUND

The present disclosure generally relates to luminaires such as a lamp for use in an office or residential setting. More particularly, the present disclosure relates to a luminaire having light emitting diode (LED) based light engine.

Since the light bulb was invented, there has been an ongoing quest to continue to improve the quality, efficiency and performance of light bulbs. Such improvements have lead to the development of more improved light bulbs using other materials and types of bulbs such as halogen, fluorescent, sodium, high intensity discharge, metal halide and many others. Such ongoing innovation efforts have lead to the development of compact fluorescent light (CFL) bulbs which are far more efficient than traditional incandescent light bulbs. It has also been generally known that electronic-based, solid state lights are even more efficient and have a lower environmental impact than CFL bulbs. Such generally known solid state lights include light sources using light emitting diodes (LEDs) which have been generally known and used due to their generally high energy efficiency and luminous efficacy.

However, packaging LEDs for use in a lamp remains a challenge. In particular, there remains a need to improve the packaging of the LEDs for use in a lamp that will improve the maximum density and energy efficiency of the resulting lamp. Further, there long remains significant challenges and technical hurdles to achieving similar form factors for LED lamps as compared to incandescent and compact fluorescent light bulbs. Despite the greater efficacy offered by light emitting diodes (LEDs), the obstacles to providing readily usable and affordable lamps include high heat density, temperature related color balance, and desirable light distribution. Accordingly, there long remains a need to improve such devices.

### SUMMARY

The present disclosure relates to a general illumination luminaire using Light Emitting Diodes (LEDs). While most Solid State Lighting (SSL) seeks to create replaceable light modules using standard Edison-type, threaded, screw-in plugs and sockets, this disclosure applies multiple LEDs, such as a strip containing multiple LEDs, directly to a supporting frame that acts as the permanent light module without using common, standard plugs and sockets. The supporting frame provides LED location for desired light distribution and heat dissipation to enable relatively extremely long lifetimes. The electrical connection may be made through soldered components on printed circuit technology or any other known or appropriate electrical connection.

In one exemplary embodiment there is disclosed a luminaire having a base for supporting a pedestal upon which is mounted a light generation module having a plurality of LEDs. The light module includes a rigid frame having the LEDS in mechanical and thermal contact with the rigid frame and arranged to emit light for general illumination. In one exemplary embodiment, the luminaire may further include a light diffuser and a shade for light reflection, diffusion, transmission, and visual effects. The light diffuser is position with respect to the light generation module to diffuse light from the LEDs through either reflection or transmission or some combination thereof. The luminaire may further include a shade to provide an aesthetic visual appeal and to further diffuse, direct and/or color the light from the light generation module and light diffuser. As light exits from the luminaire through an opening, such as an aperture located in a top, bottom and/or sides of the shade. The shade may be opaque or partially translucent. In one exemplary embodiment, the luminaire is structured as a pendant lamp for hanging from a ceiling, post or other support.

In one exemplary embodiment, the rigid frame of the luminaire is made from a metal material having a relatively high thermal conductivity and heat capacity. The rigid frame may be formed as closed or open surface with design features for increasing the heat radiation and convection of the rigid frame to dissipate heat from the LEDs. In one exemplary embodiment, the rigid frame of the luminaire is made from aluminum. In one exemplary embodiment, the rigid frame of the luminaire is arranged to have the LEDs aligned to radiate light radially outward, or in an alternative embodiment inward (or both), and the rigid frame forms a thermal contact and heat dissipation device.

In one exemplary embodiment there is disclosed a luminaire having a light generation module having a plurality of LEDs. The light generation module includes a rigid frame having a plurality of LEDS coupled together as part of a flexible circuit having a plurality of holes in the flexible circuit and each hole being aligned with an LED such that the LED will be in mechanical and thermal contact with the rigid frame when the flexible circuit is adhered to the frame. In one exemplary embodiment, the LEDs are coupled to a flexible circuit that wraps the rigid frame so the LEDs have thermal contact with the rigid frame through the flexible circuit.

### BRIEF DESCRIPTIONS OF THE DRAWINGS

FIG. 1 depicts a light emitting diode-based luminaire shown as a table lamp for general illumination according to an exemplary embodiment.

FIG. 2 depicts a light emitting diode-based luminaire shown as a pendant lamp for general illumination according to an exemplary embodiment.

FIG. 3 depicts the light emitting diode (LED) module showing the LED integrated circuits mounted on a cylindrical metal sheet for light distribution positioning and heat sinking according to an exemplary embodiment.

FIG. 4 is a side view of the LED module shown in FIG. 3.

FIG. 5 is a top view of the LED module shown in FIG. 3.

FIG. 6 is a side view of an alternate embodiment of a LED module.

FIG. 7 is a top view of the alternate embodiment LED module shown in FIG. 6.

FIG. 8 is a partial, plan view of the LED module of the exemplary embodiment of FIG. 1.

FIG. 9 is a partial, plan view of an LED module of an alternate exemplary embodiment.

### DETAILED DESCRIPTION

Referring generally to the Figures and in particular to FIG. 1, there is shown a perspective view of a general illumination luminaire or lamp 10 generally in the form of a table lamp. The lamp 10 includes a light emitting diode (LED) based module or light generation module or light engine 12, an outer shade 14, a stem or pedestal 16, and a base 18 in accordance with the aspects of the present disclosure. The luminaire 10 is useful in many different applications including as a task or work light or as an aesthetic office or residential light. The luminaire 10 includes electronic components including LEDs, a power supply that conditions the electrical source to provide appropriate energy to the LEDs, and a battery (or a power cord and converter) as a power source. The light from the LEDs is emitted in a generally cylindrical pattern although other two and three dimensional and asymmetric patterns are possible to achieve desired visual effects. Upon impinging on or reflecting against the inner diffuser 13 the light emitted from the LEDs is diffused through reflection or transmission or a combination thereof. Further, the diffusion of the light may not be complete and may include a fraction of specular reflection to achieve a particular desired visual effect. The light reflected from the inner diffuser may undergo further reflections from the inner diffuser 13 before exiting the luminaire as useful illumination from the top or bottom apertures. Some portion of the light may also exit the luminaire by transmission through the inner diffuser 13 and outer shade 14.

Preferably, the inner diffuser 13 absorbs only a minor fraction of the incident light that is reflected or transmitted. The inner diffuser 13, and/or the outer shade 14, may also be designed to affect, change or impact the color distribution of the incident light through filtering, fluorescence of phosphorescence in order to create a more desirable visual effect, such as a warmer color white light. Materials that may act as a diffuser include spunbonded olefins in a sheet material, such as Tyvek® brand material manufactured by DuPont. Fluorescent or phosphorescent coatings are similar to those used in LED chip assemblies to shift light wavelengths in the blue spectral region, so called “cool” colors, to longer wavelengths. The LED density on the inner frame is chosen to achieve a variety of light patterns.

While the luminaire 10 is shown with the light sources 22 arranged to radiate outward toward the diffuser 13 and shade 14, the light emitting direction, diffuser 13 and shade 14 can have different positional relationships. That is, the LEDs 22 can be aligned to radiate radially inward and the diffuser 13 would be positioned on the concave side of frame 20. Regardless, shade 14 will most likely still be the outermost surface of luminaire 10 and may have diffuser 13 integrated as a coating or an adhered layer and may also have the frame 20 coupled, adhered or coated on. The functions and location of the frame 20, diffuser 13, and shade 14 in relation to each other may be coupled or combined in various ways to achieve desired visual effects. It should be understood that the component and functional relationships shown in the figures are intended for illustrative purposes and once the above is understood, other arrangements become possible. The functional purposes of each are used in varying degrees to achieve desired visual effects.

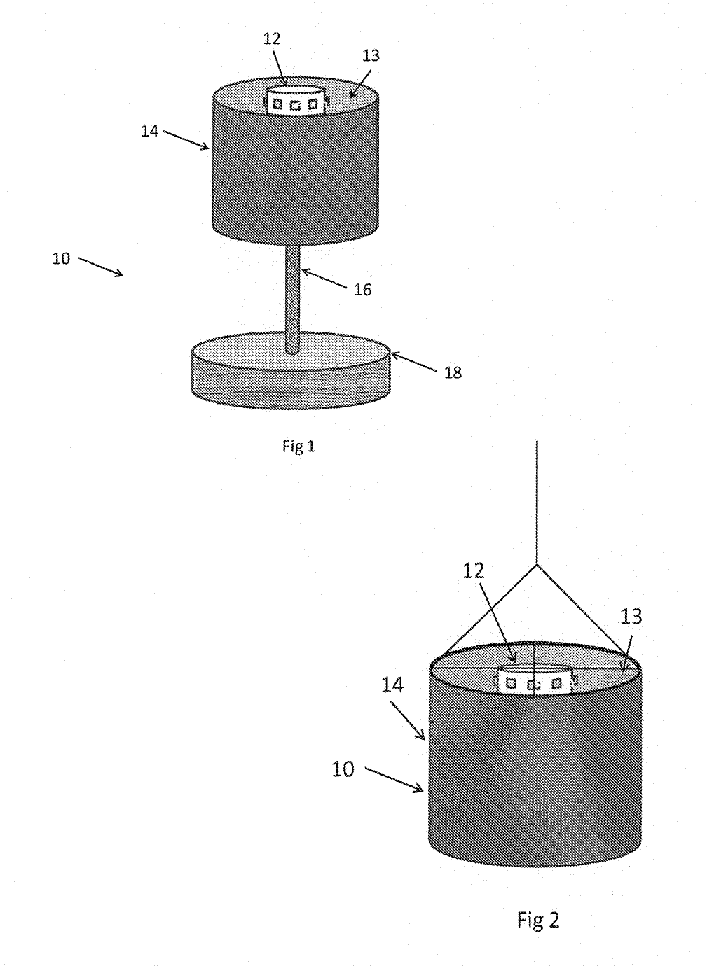

FIG. 2 is a perspective view of a luminaire similar to that depicted in FIG. 1 but configured as a pendant lamp, with most of the same components except the base and pedestal.

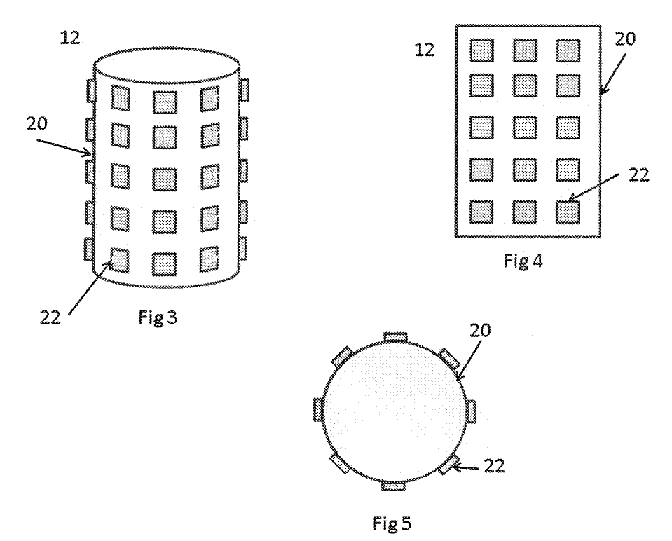

FIG. 3 is a perspective view of the Light Emitting Diode module, 12, of the luminaire assembly 10. Shown is an array of Light Emitting Diodes 22 mounted on a cylindrical frame 20 to position the diodes and provide effective heat dissipation. The frame 20 is designed to include holders for the electronic control components and the power source. Two significant features of the frame 20 are the light source positioning and heat dissipation. The Light Emitting Diodes 22 generate heat through power dissipation which does not contribute to light output and may hinder light generation efficiency and color balance by contributing to a rise in the light emitting diode semiconductor junction temperature. Maximizing the heat transfer away from each diode 22 allows the junction temperature to stay low thereby maximizing lifetime and light output consistency.

The frame 20 is preferably comprised of a high thermal conductivity and heat capacity material (such as Aluminum or other similar materials) that allows for maximum heat transfer from the LEDs 22. Further, formed geometric features of the frame 20 will increase, and hopefully maximize, radiative and convective cooling to maintain the frame 20 temperature within a touch-safe temperature (below less than about 120 degrees Fahrenheit). Two common methods of mounting and providing LEDs 22 include Metal Clad Printed Circuit Boards, (MCPCBs), and flexible circuits typically employing a polyimide material as the flexible substrate with a thin copper layer adhered to the flexible polymer.

The MCPCBs offer very good heat transfer from the LED 22 using the soldered connections as conductive heat transfer vias as well as non-electrical connection to the underlying metal layer, typically Aluminum. Preferably the MCPCBs can be affixed to the frame 20 to maximize conductive heat transfer. Candidate MCPCBs are made by Berquist Co. but any known or appropriate MCPCB may be used provided it meets the requirements set forth herein.

While the flexible circuits can be adhered to the frame 20 that results in the polymer based flexible substrate impeding conducted heat transfer due to its relatively lower heat conductivity. For example, FIGS. 8 and 9 provide examples of two possible approaches for connecting of coupling the flexible circuit and thereby the LED 22 to the frame 20. FIG. 8 shows where the flexible circuit is adhered using an adhesive 41 to the frame 20 and the LEDs 22 are coupled to the flexible circuit substrate 43 and then masked with a solder mask 45.

In the exemplary embodiment of FIG. 9, the LED 22 is directly attached or adhered to the frame 20. The LEDs 22 are located in an aperture in the flexible circuit substrate 43 such that the LED 22 is mechanically and thermally bonded to the frame 20 by the adhesive 41 for improved positioning and heat dissipation.

The frame 20 in one embodiment is preferably composed of an aluminum sheet material but may alternatively be formed any known or appropriate metal or other material appropriate for the particular application. The frame 20 is also preferably formed in a cylindrical, conical, rectangular, spherical, or helical shape or some combination thereof or in any other known or appropriate configuration which provides a surface for directing the light from the LED 22. As best shown in FIG. 9, in one exemplary embodiment, the LEDs 22 are mounted on one side of the frame member 20 surface to maximize convective and radiative heat transfer with the other surface of the frame 20.

Alternatively, both surfaces of the frame 20 may be utilized for mounting LEDs 22 to achieve particular compactness and/or visual effect. That is, the LEDs 22 can radiate light either radially outward, radially inward or both. The frame 20 may be closed to form a generally tubular shape, such as shown in FIG. 3 through 5, or the frame 20 may alternatively be formed as a generalized curved surface with an open portion, such as a half cylinder or other similar shape.

In any of the described embodiments and methods, it is contemplated that heat transfer is optimized through the use of thermal compound grease or epoxy, gap pad, gel, or other similar material located between the LEDs 22 and the frame 20 or between the LED and the substrate 43, upon which the LEDs 22 are mounted, and between the substrate 43 and the frame 20. The thermal compound grease or epoxy preferably has a thermal conductivity of approximately 1.6 to approximately 270 watts/meter Kelvin.

Further, the thermal conductivity of the materials used in each part is preferably selected to provide the light engine 12 and the luminaire 10 with an improved thermal conductivity and efficiency. In particular, the solder mask 45 has a thermal conductivity of approximately 0.2 watts/meter Kelvin; the flexible circuit 43 has a thermal conductivity of approximately 0.12 to approximately 0.37 watts/meter Kelvin; the adhesive 41 has a thermal conductivity of approximately 0.1 to approximately 0.6 watts/meter Kelvin; and the thermal conductivity of the frame material is approximately 200 to approximately 400 watts/meter Kelvin.

FIG. 4 is a side plan view of FIG. 3 showing the LEDs 22 mounted on the outer surface of the frame 20 to emit light radially outward. Frame 20 may be of any appropriate size and scale wherein the LEDs 22 are arranged on the concave surface to emit light radially inward to achieve a desired visual effect.

FIG. 5 is a top view of FIG. 3 showing the radial spacing of the LEDs 22 of the substrate 43 of the integrated strip circuit. It is possible to have the LEDs 22 more closely co-located (i.e., there is less radial space between each LED 22) on the substrate 43 to provide a higher density of LEDs 22 in a given space and thus a higher illumination from the LED light engine module 12 and the luminaire 10.

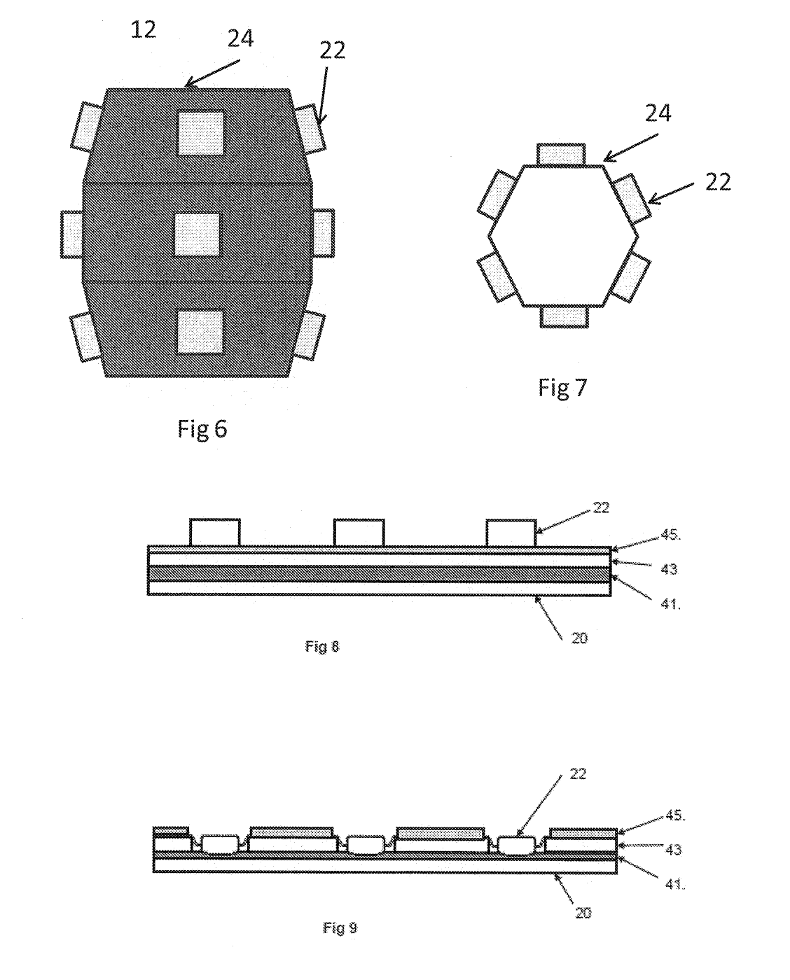

FIG. 6 is a side view of an alternate exemplary embodiment of the LED module 12 showing the Light Emitting Diodes 22 mounted on a frame 24 formed to direct the light from the diodes in a generally omni-directional pattern. As mentioned above, the frame 24 could also be formed as an open surface, as opposed to the closed surface shown in the figure, and the LEDs 22 mounted on either surface to achieve a desired visual effect.

FIG. 7 is a top view of FIG. 6 depicting the possible density of LED integrated circuits. Similar to the embodiment of FIG. 5, it is possible to have the LEDs 22 in FIG. 72 more closely co-located (i.e., there is less distance between each LED 22) on the substrate 43 to provide a higher density of LEDs 22 in a given space and thus a higher illumination from the LED light engine module 12 and the luminaire 10.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical range provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or movable (e.g., removable or releasable). Such joining may be achieved with two members or the two members and any additional intermediate members being integrally formed as a single unitary body with one another or with the two members of the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the luminaire structure as shown in the various exemplary embodiments is illustrative only. Although only a few exemplary embodiments are described in detail in this disclosure, those skilled in the art who review this disclosure will readily appreciate that many modifications become possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions and alternative applications may also be made in the design, operating conditions and arrangement of the various exemplary embodiments without departing from the scope of the present invention.

What is claimed is:

1. A luminaire, comprising:
a. a light generation module comprising a rigid frame having a plurality of light emitting diodes in mechanical and thermal contact with the rigid frame and arranged to emit light for general illumination;
b. a light diffuser to diffuse light from the light emitting diodes through either reflection or transmission or some combination thereof;
c. a shade to provide aesthetic visual appeal and to further diffuse, direct or color the light from the light generation module and light diffuser; and
d. a base for supporting the light generation module, light diffuser and shade wherein light exits from the luminaire through top or bottom apertures or through sides of shade.

2. The luminaire of claim 1 wherein the rigid frame comprises a metal material having a relatively high thermal conductivity and heat capacity, the rigid frame being formed as closed surface to increase heat dissipation.

3. The luminaire claim 2 wherein the metal material of the rigid frame comprises aluminum.

4. The luminaire of claim 3 wherein the rigid frame is arranged to have the LEDs aligned thereon to radiate light radially outward and the rigid frame forms a thermal contact heat dissipation device.

5. The luminaire of claim 4 wherein the light diffuser for diffusing the light from the LEDs diffuses the light having seculars reflection and transmission while reducing absorption and wherein the light diffuser is located between the LED light source and the shade.

6. The luminaire claim 1 wherein the rigid frame has a substantially round configuration and the light emitting diodes are provided as a strip that is wrapped around the rigid frame.

7. The luminaire of claim 1 further comprising a power control and a conditioning electronic circuit for providing electrical power to the LEDs of the light generation module.

8. The luminaire of claim 7 further comprising a battery for use as a power source and wherein the battery is mounted in one of the base and the rigid frame.

9. The luminaire of claim 1 wherein the rigid frame of light generation module has a three dimensional surface selected from the group comprising: polygonal, cylindrical, conical, helical, spheroidal, or a curvilinear surface and wherein the rigid frame is configured to maximize convection away from the light generation module and the luminaire.

10. The luminaire of claim 7 wherein the LEDs are coupled to the rigid frame to maximize heat conductance away from LED to be dissipated by the rigid frame.

11. The luminaire of claim 1 wherein the LEDs are coupled on a flexible circuit that wraps the rigid frame so the LEDs have direct thermal contact with the rigid frame.

12. The luminaire of claim 9 wherein the LEDs are coupled on a MCPCB which is coupled to the rigid frame for enhanced heat dissipation.

13. The luminaire of claim 11 wherein a thermal compound in the form of grease, gel, pad is applied to maximize heat transfer between the LED and the rigid frame.

14. A luminaire, comprising:
a. a frame member;
b. a light emitting diode (LED) in mechanical and thermal contact with the frame member and arranged to emit light for general illumination; and
c. a diffuser for diffusing light from the light emitting diode, the diffuser being arranged with respect to the light emitting diode such that light is reflected by the diffuser.

15. The luminaire of claim 14 further comprising:
a. a shade having an aperture, the shade for covering at least a portion of the frame member and the LED; and
b. wherein light exiting from the LED will reflect from the diffuser and exit through the aperture in the shade.

16. The luminaire of claim 15 wherein the frame member comprises a metal material having a relatively high thermal conductivity and heat capacity and the rigid frame member is formed as a closed surface with features to maximize heat radiation and convection.

17. The luminaire of claim 15 wherein the frame is arranged to have the LEDs aligned to radiate light radially outward or inward, and the frame forms a thermal contact & heat dissipation device

18. The luminaire of claim 15 wherein the light diffuser comprises a color filter that modifies the reflected light.
